(19) United States
(12) Patent Application Publication
(10) Pub. No.: US 2017/0278107 A1
(43) Pub. Date: Sep. 28, 2017

(54) System and Method for Authenticating Network Transaction Trustworthiness

(71) Applicant: TONGJI UNIVERSITY, SHANGHAI (CN)

(72) Inventors: CHANGJUN JIANG, SHANGHAI (CN); HONGZHONG CHEN, SHANGHAI (CN); CHUNGANG YAN, SHANGHAI (CN); ZHIJUN DING, SHANGHAI (CN); WANGYANG YU, SHANGHAI (CN); YONGLONG GE, SHANGHAI (CN)

(73) Assignee: TONGJI UNIVERSITY, SHANGHAI (CN)

(21) Appl. No.: 15/504,811

(22) PCT Filed: Dec. 31, 2014
(86) PCT No.: PCT/CN2014/095897

§ 371 Date: Feb. 17, 2017

(30) Foreign Application Priority Data
Sep. 25, 2014 (CN) 201410499859.1

(51) Int. Cl. G06Q 20/40; G06Q 20/38; G06Q 20/02

(52) U.S. Cl. CPC G06Q 20/405; G06Q 20/027; G06Q 20/3821; G06Q 20/382; G06F 17/30365

(57) ABSTRACT

A system and method for authenticating network transaction trustworthiness, a bottom layer of the system supports two mainstream operating systems, i.e., Windows and Linux; basic management modules, i.e., respectively a communication management module, a certificate management module and a database management module are above the bottom layer support; a fourth-party authentication domain is above the foundation management modules; a user domain, an E-merchant domain, a third-party payment domain and the like are also provided. The method comprises the steps: 1) when a network transaction occurs, uploading, by a user, a digital certificate to perform digital authentication by logging into a security client, and simultaneously uploading, by an E-merchant and a third-party payment platform, digital certificates thereof to perform corresponding digital authentication; 2) after the digital authentication passes, downloading, by the user, a behavior certificate through a user behavior certificate downloading module, and formally entering, by the three parties, a transaction process; etc.

### BACKGROUND OF THE PRESENT INVENTION

Field of Invention The present invention relates to the technical field of authenticating network transaction trustworthiness.

Description of Related Arts

With the quick development of Internet and the continuous progress of computer science and technology, network transaction based on Internet is vigorously and rapidly developed, and this not only provides continuous power for the development of Chinese economy, but also brings great convenience to the living of vast people. More and more people carry out business activities through network transactions and payment modes, and the development prospect of network transaction is very wide.

However, since network transaction and payment platforms have emerged for a short time, the security system of network payment is not prefect, the problem of the trustworthiness of network transaction processes and behaviors becomes increasingly outstanding, and it has already gradually been a bottleneck problem confronted by the development of the network transaction. The problem of trustworthiness in the network transaction mainly comprises two aspects, wherein one is the user identity trustworthiness problem, i.e., whether the identity of the user participating in the network transaction is legal or not; and the other is the software trustworthiness problem, i.e., whether behaviors of software of all transaction parties in the network transaction and behaviors of interaction between software are expectable or not. Aiming at the two classes of problems, at present, E-commerce enterprises generally adopt the solutions of digital certificates and patch update or version upgrade of software. As investigated and surveyed, by taking a large network payment platform company in China as an example, the current solution strategies have obvious defects in industrial application, wherein one is that, after account passwords of a user are stolen, transactions performed by hackers through a stolen user account cannot be recognized and the problem of user identity trustworthiness which jeopardizes user benefits occurs; and the other is that unexpected behaviors met during system operation cannot be found and processed in time. A main cause of these defects is that there is a lack of a system for authenticating network transaction trustworthiness to monitor and manage all transaction parties and transaction behaviors.

### SUMMARY OF THE PRESENT INVENTION

Aiming at the problems that network transaction user identity trustworthiness and software behavior trustworthiness of all transaction parties cannot be guaranteed at present and the situation that there is a lack in effectively monitoring and managing network transaction trustworthiness, the present invention provides a solution to the problem of authentication of user identity trustworthiness and software behavior trustworthiness by adopting user behavior certificates and software behavior certificates.

Network transaction trustworthiness authentication is realized by establishing a fourth-party authentication center and a security client for network transactions, deploying software monitors on an E-commerce website and a payment platform to form a network transaction trustworthiness authentication system platform, and formulating authentication protocols for network transaction trustworthiness authentication. In a network transaction trustworthiness authentication system, the fourth-party authentication center is mainly responsible for managing user behavior and software behavior certificates and authenticating trustworthiness of software behaviors; the security client is mainly responsible for acquiring user netsurfing logs in real time, authenticating trustworthiness of user behaviors and simultaneously acquiring and uploading client software behaviors in a network transaction to the fourth-party authentication center; and the software behavior monitors are responsible for acquiring and uploading software behaviors of an E-merchant and the payment platform in the network transaction to the fourth-party authentication center in real time.

The technical solution provided by the present invention is as follow:

A network transaction trustworthiness authentication system is characterized in that a bottom layer of the network transaction trustworthiness authentication system supports two mainstream operating systems, i.e., Windows and Linux, has a very good cross-platform ability and provides a good support for application development of an upper layer; three basic management modules, i.e., respectively a communication management module, a certificate management module and a database management module at a comparatively low layer are above the support of the bottom layer. The communication management module is mainly responsible for packaging a network communication function according to a specific demand of the system, providing communication services such as data exchange for the upper layer and providing the communication services to a fourth party in a network transaction for calling to perform data exchange; the certificate management module is responsible for performing uniform management to a software behavior certificate, a user behavior certificate and a digital certificate, including operations such as searching, updating and issuance of certificates; the database management module is mainly responsible for updating and maintaining a database and improving data access efficiency. A fourth-party authentication domain of the network transaction trustworthiness authentication system is above the basic management modules and mainly has functions of monitoring and authenticating a network transaction process, performing digital authentication to three transaction parties, verifying trustworthiness of user identity through the user behavior certificate and verifying trustworthiness of a network transaction behavior of the three transaction parties through the software behavior certificate. The fourth-party authentication domain is divided into three sub-parts i.e., the digital certificate, the user behavior certificate and the software behavior certificate to perform triple authentication to the network transaction process. Other three domains, i.e., a user domain, an E-merchant domain and a third-party payment domain of the network transaction trustworthiness authentication system are above the fourth-party authentication domain. The user domain is mainly responsible for uploading the user digital certificate, verifying the user identity through the user behavior certificate as well as acquiring and uploading a client software behavior in the transaction process. The E-merchant domain and the third-party payment domain mainly have functions of uploading digital certificates thereof, as well as acquiring and uploading software behaviors.

A network transaction trustworthiness authentication method is characterized in that the network transaction trustworthiness authentication method comprises the following steps:

1) when a network transaction occurs, uploading, by a user, a digital certificate to perform digital authentication by logging into a security client, and simultaneously uploading, by an E-merchant and a third-party payment platform, digital certificates thereof to perform corresponding digital authentication;

2) after the digital authentication passes, downloading, by the user, a behavior certificate through a user behavior certificate downloading module, and formally entering, by the three parties, a transaction process;

3) in the transaction process, acquiring, by the security client, a user behavior in real time through a user behavior acquisition module, providing the user behavior to a user behavior authentication module, and authenticating trustworthiness of a current user access behavior according to the user behavior certificate downloaded from a fourth-party authentication center. If authentication passes, continuously acquiring a user access behavior and performing authentication; if the authentication fails, uploading a detailed authentication result to the authentication center, and performing, by the authentication center, examination and judgment; simultaneously, acquiring a client software behavior in real time through a software behavior acquisition module, and uploading, by a communication interaction module, the client software behavior to the authentication center; also acquiring, by the E-merchant and the third-party payment platform, software behaviors thereof in real time through software behavior monitoring modules, and uploading, by communication interaction modules, the software behaviors to the authentication center; if software behavior authentication passes, sending, by the authentication center, feedback information, continuously performing the transaction process, and continuously performing real-time acquisition and monitoring to software behaviors of the three parties; and if the authentication fails, giving, by the authentication center, a broadcast notice about that abnormality occurs in the transaction process to the three parties of the transaction, and terminating the transaction;

4) after the transaction is completed, uploading, by the security client, a new access log to the authentication center through a user access log uploading module; sending, by the authentication center, feedback information after receiving the new access log, and exiting, by the user, the security client; and

5) then calling, by the authentication center, a user behavior certificate mining module through a certificate management module to mine the new user access log, and updating the behavior certificate of the user.

When a new E-merchant or a new third-party payment platform is added, firstly auditing is performed thereto and a digital certificate is issued after the auditing passes; and then a corresponding software behavior certificate thereof is mined by analyzing a website source code thereof, is uploaded to the authentication center and is uniformly managed by a behavior certificate management module.

The present invention monitors and authenticates the trustworthiness of the user identity and software behaviors in the network transaction process by adopting the fourth-party authentication center. For this purpose, the present invention establishes system architecture of a four-party network transaction trustworthiness authentication system, and performs triple authentication, i.e., digital authentication, user behavior authentication and software behavior authentication to the network transaction process to guarantee the trustworthiness and security of the network transaction. The present invention has very good extensibility, transportability and universality, configuration and deployment are flexible and convenient to perform, and no third-party software support is needed.

### BRIEF DESCRIPTION OF THE DRAWINGS

FIG. 1A is a part of an architecture diagram of a network transaction trustworthiness authentication system.

FIG. 1B is a part of an architecture diagram of a network transaction trustworthiness authentication system.

FIG. 2 is a module deployment diagram of a network transaction trustworthiness authentication system.

FIG. 2A is a part of the FIG. 2.

FIG. 2B is a part of the FIG. 2.

FIG. 2C is a part of the FIG. 2.

FIG. 2D is a part of the FIG. 2.

FIG. 3A is a part of an authentication flowchart of a network transaction trustworthiness authentication system.

FIG. 3B is a part of an authentication flowchart of a network transaction trustworthiness authentication system.

### DETAILED DESCRIPTION OF THE PREFERRED EMBODIMENTS

### Examples

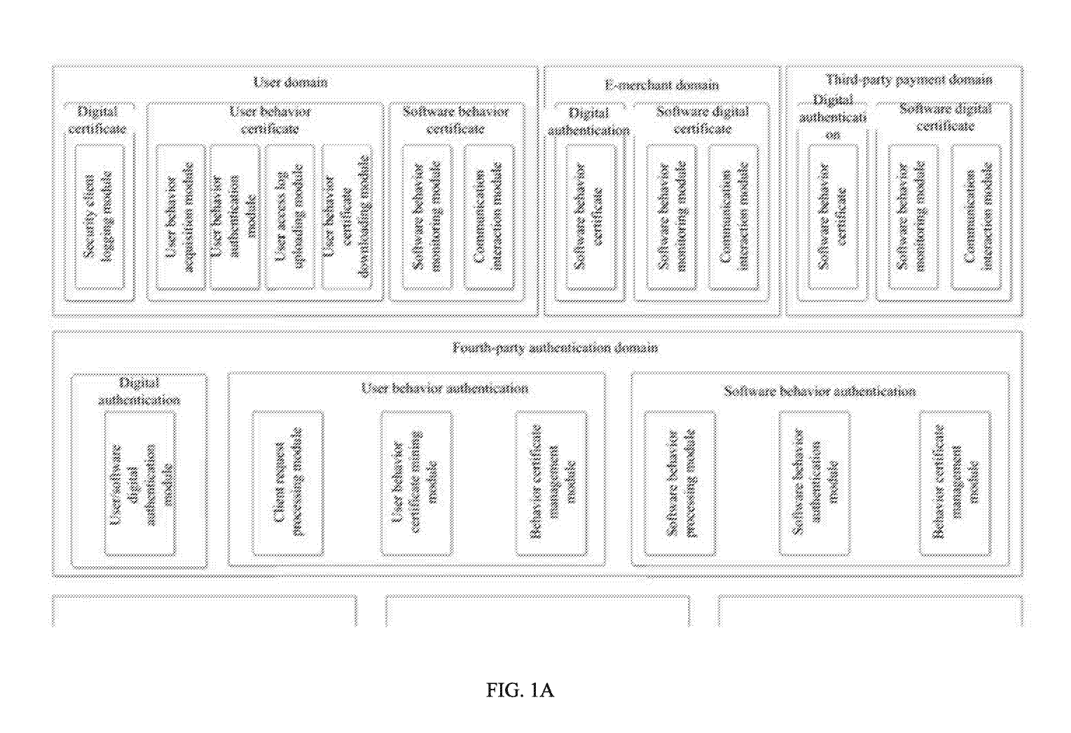

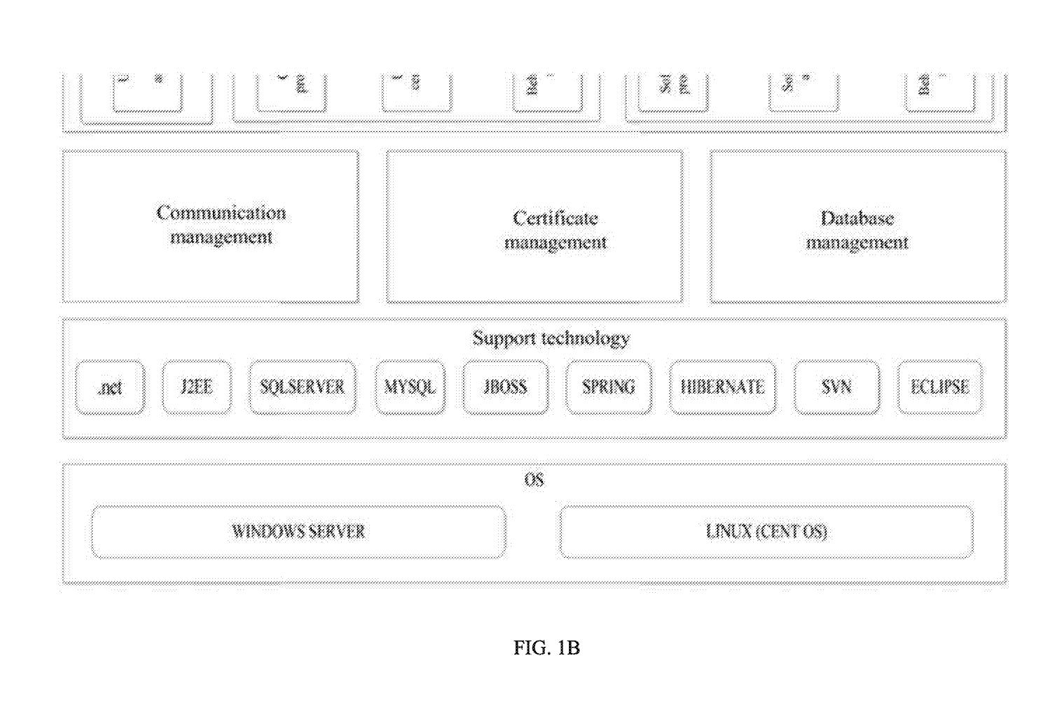

FIG. 1 illustrates an architecture diagram of a network transaction trustworthiness authentication system.

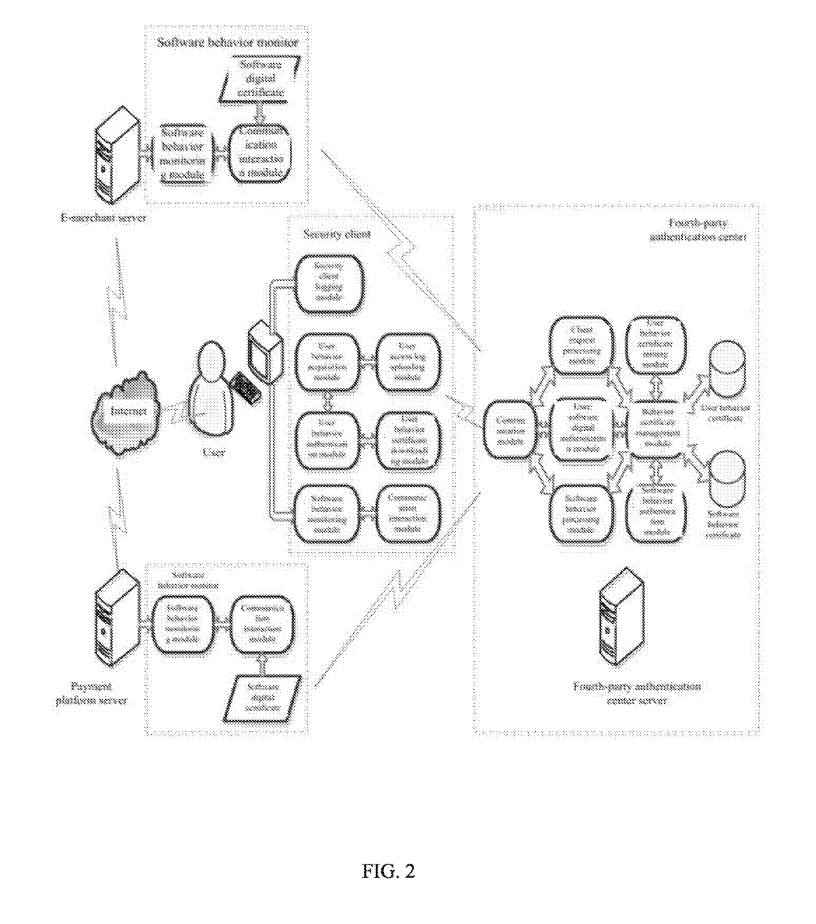

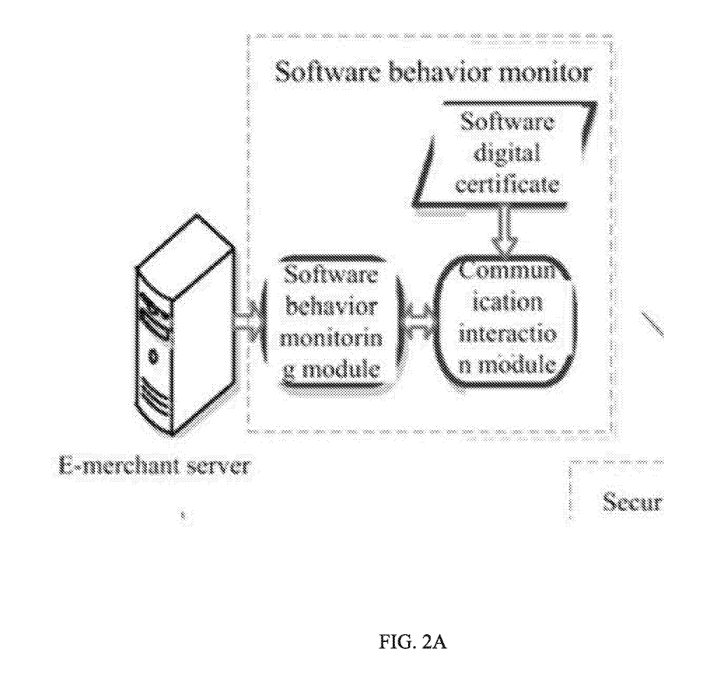

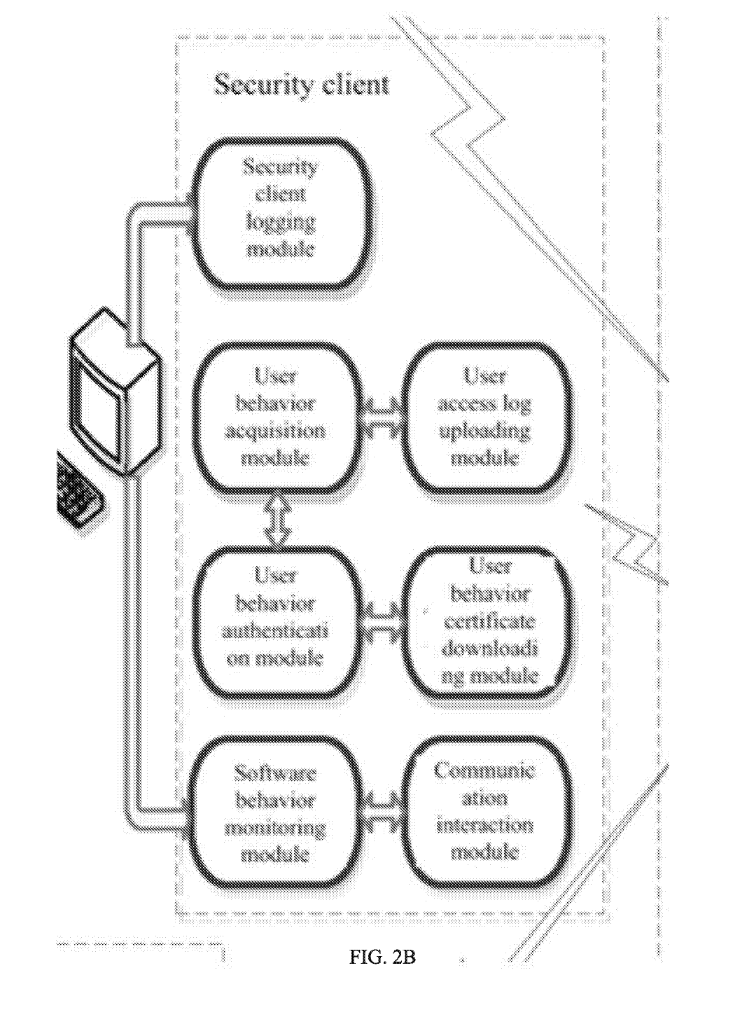

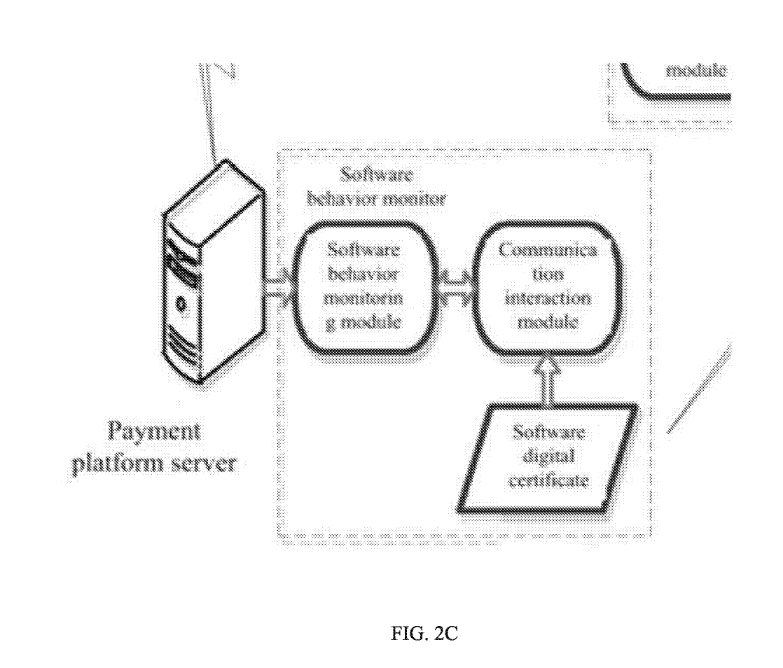

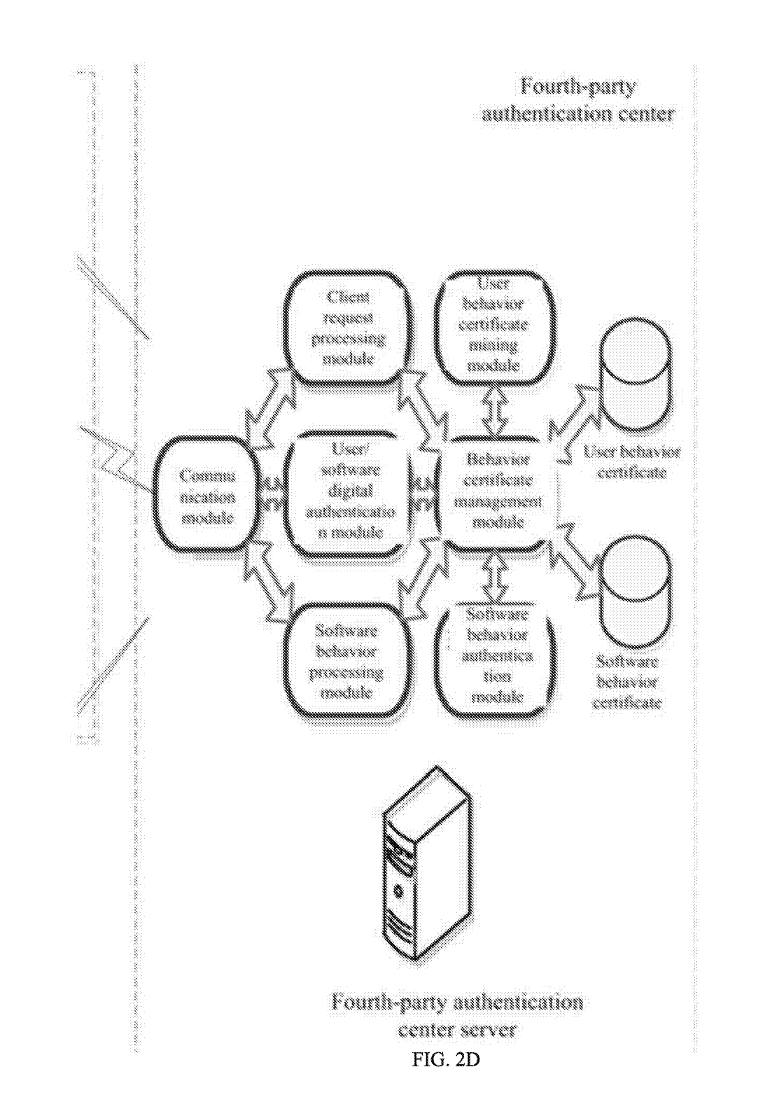

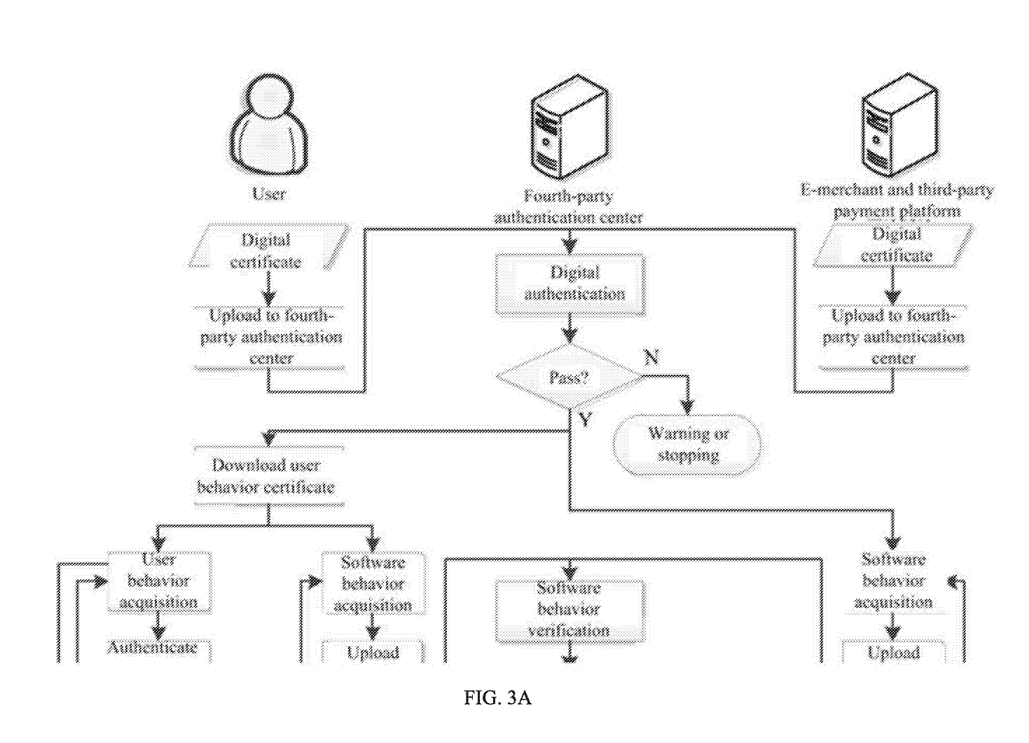

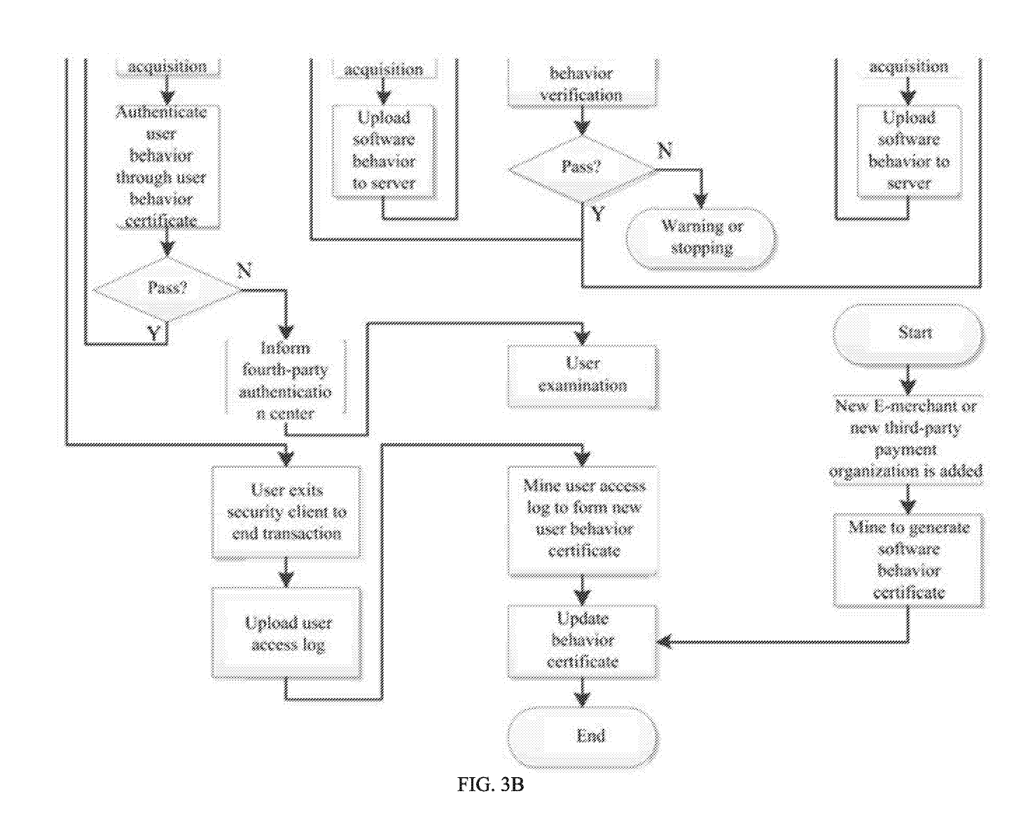

As illustrated in FIG. 1, a bottom layer of the network transaction trustworthiness authentication system supports two mainstream operating systems, i.e., Windows and Linux, thus not only can be deployed on a Window system, but also can be deployed on a Linux system, and has very good cross-platform ability. Support technologies comprise .net, J2EE, SqlServer, MySql, JBoss, SPRING, HIBERNATE, etc., and provide a good support for application development of an upper layer. Three basic management modules, i.e., respectively a communication management module, a certificate management module and a database management module at a comparatively low layer are above the support technologies. The communication management module is mainly responsible for packaging a network communication function according to a specific demand of the system, providing communication services such as data exchange for the upper layer and providing the communication services to a fourth party in a network transaction for calling to perform data exchange; the certificate management module is responsible for performing uniform management to a software behavior certificate, a user behavior certificate and a digital certificate, including operations such as searching, updating and issuance of certificates; and the database management module is mainly responsible for updating and maintaining a database and improving data access efficiency. A fourth-party authentication domain of the network transaction trustworthiness authentication system is above the basic management modules and mainly has functions of monitoring and authenticating a network transaction process, performing digital authentication to three transaction parties, verifying trustworthiness of user identity through the user behavior certificate and verifying trustworthiness of a network transaction behavior of the three transaction parties through the software behavior certificate. The fourth-party authentication domain is divided into three sub-parts i.e., the digital certificate, the user behavior certificate and the software behavior certificate to perform triple authentication to the network transaction process. Other three domains, i.e., a user domain, an E-merchant domain and a third-party payment domain of the network transaction trustworthiness authentication system are above the fourth-party authentication domain. The user domain is mainly responsible for uploading the user digital certificate, verifying the user identity through the user behavior certificate as well as acquiring and uploading a client software behavior in the transaction process. The E-merchant domain and the third-party payment domain mainly have functions of uploading digital certificates thereof, as well as acquiring and uploading software behaviors. Deployment situations of all function modules of the network transaction trustworthiness authentication system and an authentication protocol process of entire system operation are given below, as illustrated in FIG. 2 and FIG. 3.

As illustrated in FIG. 2 and FIG. 3, the authentication protocol process of the entire network transaction trustworthiness authentication system comprises the following steps: when a network transaction occurs, a user uploads a digital certificate to perform digital authentication by logging into a security client, and an E-merchant and a third-party payment platform simultaneously uploads digital certificates thereof to perform corresponding digital authentication. After the digital authentication passes, the user downloads a behavior certificate through a user behavior certificate downloading module, and the three parties formally enter a transaction process. In the transaction process, the security client acquires a user behavior in real time through a user behavior acquisition module, provides the user behavior to a user behavior authentication module, and authenticates trustworthiness of a current user access behavior according to the user behavior certificate downloaded from a fourth-party authentication center. If authentication passes, continuously acquire a user access behavior and perform authentication; if the authentication fails, upload a detailed authentication result to the authentication center, and perform examination and judgment by the authentication center. Simultaneously, acquire a client software behavior in real time through a software behavior acquisition module, and upload the client software behavior to the authentication center by a communication interaction module. Also the E-merchant and the third-party payment platform acquire software behaviors thereof in real time through software behavior monitoring modules, and communication interaction modules uploads the software behaviors to the authentication center. If software behavior authentication passes, the authentication center sends feedback information, the transaction process is continuously performed, and real-time acquisition and monitoring to software behaviors of the three parties are continuously performed; and if the authentication fails, the authentication center gives a broadcast notice about that abnormality occurs in the transaction process to the three parties of the transaction, and the transaction is terminated; After the transaction is completed, the security client uploads a new access log to the authentication center through a user access log uploading module, the authentication center sends feedback information after receiving the new access log, and the user exits the security client. Then, the authentication center calls a user behavior certificate mining module through a certificate management module to mine the new user access log, and updates the behavior certificate of the user. When a new E-merchant or a new third-party payment platform is added, firstly auditing is performed thereto and a digital certificate is issued after the auditing passes; and then a corresponding software behavior certificate thereof is mined by analyzing a website source code thereof, is uploaded to the authentication center and is uniformly managed by a behavior certificate management module.

What is claimed is:

1. A network transaction trustworthiness authentication system, characterized in that, a bottom layer of the network transaction trustworthiness authentication system supports two mainstream operating systems, i.e., Windows and Linux, has a very good cross-platform ability and provides a good support for application development of an upper layer;
three basic management modules, i.e., respectively a communication management module, a certificate management module and a database management module at a comparatively low layer are above the bottom layer support; the communication management module is mainly responsible for packaging a network communication function according to a specific demand of the system, providing communication services such as data exchange for the upper layer and providing the communication services to a fourth party in a network transaction for calling to perform data exchange; the certificate management module is responsible for performing uniform management to a software behavior certificate, a user behavior certificate and a digital certificate, including operations such as searching, updating and issuance of certificates; the database management module is mainly responsible for updating and maintaining a database and improving data access efficiency;
a fourth-party authentication domain of the network transaction trustworthiness authentication system is above the basic management modules and mainly has functions of monitoring and authenticating a network transaction process, performing digital authentication to three transaction parties, verifying trustworthiness of user identity through the user behavior certificate and verifying trustworthiness of a network transaction behavior of the three transaction parties through the software behavior certificate; the fourth-party authentication domain is divided into three sub-parts, i.e., the digital certificate, the user behavior certificate and the software behavior certificate to perform triple authentication to the network transaction process;
the network transaction trustworthiness authentication system further comprises other three domains, i.e., a user domain, an E-merchant domain and a third-party payment domain; the user domain is mainly responsible for uploading the user digital certificate, verifying the user identity through the user behavior certificate as well as acquiring and uploading a client software behavior in the transaction process; and the E-merchant domain and the third-party payment domain mainly have functions of uploading digital certificates thereof, as well as acquiring and uploading software behaviors.

2. A network transaction trustworthiness authentication method, comprising the following steps:
1) when a network transaction occurs, uploading, by a user, a digital certificate to perform digital authentication by logging into a security client, and simultaneously uploading, by an E-merchant and a third-party payment platform, digital certificates thereof to perform corresponding digital authentication;
2) after the digital authentication passes, downloading, by the user, a behavior certificate through a user behavior certificate downloading module, and formally entering, by the three parties, a transaction process;
3) in the transaction process, acquiring, by the security client, a user behavior in real time through a user behavior acquisition module, providing the user behavior to a user behavior authentication module, and authenticating trustworthiness of a current user access behavior according to the user behavior certificate downloaded from a fourth-party authentication center; if authentication passes, continuously acquiring a user access behavior and performing authentication; if the authentication fails, uploading a detailed authentication result to the authentication center, and performing, by the authentication center, examination and judgment; simultaneously, acquiring a client software behavior in real time through a software behavior acquisition module, and uploading, by a communication interaction module, the client software behavior to the authentication center; also acquiring, by the E-merchant and the third-party payment platform, software behaviors thereof in real time through software behavior monitoring modules, and uploading, by communication interaction modules, the software behaviors to the authentication center; if software behavior authentication passes, sending, by the authentication center, feedback information, continuously performing the transaction process, and continuously performing real-time acquisition and monitoring to software behaviors of the three parties; and if the authentication fails, giving, by the authentication center, a broadcast notice about that abnormality occurs in the transaction process to the three parties of the transaction, and terminating the transaction;
4) after the transaction is completed, uploading, by the security client, a new access log to the authentication center through a user access log uploading module, sending, by the authentication center, feedback information after receiving the new access log, and exiting, by the user, the security client; and
5) then calling, by the authentication center, a user behavior certificate mining module through a certificate management module to mine the new user access log, and updating the behavior certificate of the user.

3. The network transaction trustworthiness authentication method according to claim 2, characterized in that, when a new E-merchant or a new third-party payment platform is added, firstly auditing is performed thereto and a digital certificate is issued after the auditing passes; and then a corresponding software behavior certificate thereof is mined by analyzing a website source code thereof, is uploaded to the authentication center and is uniformly managed by a behavior certificate management module.
